(19) United States
(12) Patent Application Publication
(10) Pub. No.: US 2026/0338359 A1
(43) Pub. Date: Oct. 29, 2026

(54) ELECTRIC DEVICE

(71) Applicant: Koki Holdings Co., Ltd., Tokyo (JP)

(72) Inventors: Ryo HAYAKAWA, Ibaraki (JP); Shingo KOSUGI, Ibaraki (JP); Takeshi TANIGUCHI, Ibaraki (JP); Ri SEN, Ibaraki (JP)

(73) Assignee: Koki Holdings Co., Ltd., Tokyo (JP)

(21) Appl. No.: 19/117,636

(22) PCT Filed: Sep. 20, 2023
(86) PCT No.: PCT/JP2023/034026

§ 371 Date: Apr. 2, 2025

(30) Foreign Application Priority Data
Oct. 3, 2022 (JP) 2022-159324

(51) Int. Cl. F21V 21/088; F21L 4/00; F21V 23/00; F21Y 115/10

(52) U.S. Cl. CPC F21V 21/0885; F21L 4/005; F21V 23/003; F21Y 2115/10

(57) ABSTRACT

To improve convenience. In a flashlight 10, a hanging hook 70 is connected to a flashlight body 20 so as to be rotatable (movable) between a storage position and a hooking position. In the hooking position, since side hook sections 72L and 72R protrude so as not to substantially overlap with the flashlight body 20 and a battery pack 80, the hanging hook 70 is able to be stably hooked on a single pipe P. On the other hand, in the storage position, since the side hook sections 72L and 72R are stored so as to substantially overlap with the flashlight body 20, the hanging hook 70 is able to be compactly stored. Also, a center hook section 74 is able to stabilize the relative position of the side hook sections 72L and 72R in the hooking position. Furthermore, since the center hook section 74 does not overlap with at least the battery pack 80 in the storage position, attachment and detachment of the battery pack 80 is enabled.

### TECHNICAL FIELD

The present invention relates to an electric device.

### DESCRIPTION OF RELATED ART

The lighting fixture (electric device) described in the following Patent Literature 1 includes a light source unit and a base that is rotatably connected to the light source unit by a connection device, and a battery pack is detachably mounted to the base. In addition, a hanging hook is slidably and rotatably connected to the base. By sliding the hanging hook to a state where the hanging hook is drawn out from the base and rotating the hanging hook, the hanging hook can be hooked to an external member. This allows the lighting fixture to be hung from the external member.

### RELATED ART

### Patent Literature

Patent Literature 1: Japanese Patent Application Laid-Open No. 2019-067532

### SUMMARY

### Technical Problem

However, in the above-mentioned lighting fixture, there is room for improvement in the points shown below. That is, in the above-mentioned lighting fixture, when the hanging hook is stored along the base during non-use etc. of the lighting fixture, a part of the hanging hook and the battery pack overlap when viewed from the mounting direction side of the battery pack. That is, during attachment and detachment of the battery pack, since the hanging hook in the storage state and the battery pack interfere with each other, it is needed to move the hanging hook from the storage state. Therefore, in the above-mentioned lighting fixture, convenience may decrease, and in this respect, there is room for improvement.

The present invention aims to provide an electric device that can improve convenience in consideration of the above facts.

### Solution to the Problem

One or more embodiments of the present invention relate to an electric device which includes a body section configured to convert power to a predetermined conversion output and output the power converted forward, a battery pack detachably attached to the body section, and a hanging hook configured to be connected to the body section and hung on an external long member extending in a left-right direction. The hanging hook includes a first hook section configured to have one end connected to the body section and hook onto the long member, a second hook section configured to be provided at a position shifted in the left-right direction with respect to the first hook section, have one end connected to the body section, and hook onto the long member, and a connecting section which connects the other end of the first hook section and the other end of the second hook section so as not to move relative to each other. The hanging hook is configured to be movable between a hooking position at which when viewed from the left-right direction, the first hook section, the second hook section and the connecting section protrude so as not to substantially overlap with the body section and the battery pack and a storage position at which the first hook section and the second hook section are stored so as to substantially overlap with the body section, and the connecting section protrudes so as not to substantially overlap with at least the battery pack.

One or more embodiments of the present invention is an electric device characterized in that the body section includes an output section configured to output the conversion output, a base section configured to allow the battery pack to be detachable, and a connection section which connects the output section and the base section to be rotatable relative to each other, and the connection section and the output section and the base section positioned near the connection section are all configured to be positioned between the first hook section and the second hook section when placed in the left-right direction.

One or more embodiments of the present invention is an electric device characterized in that when the hanging hook is in the storage position, the connecting section is configured to be in a position at which the connecting section does not contact the output section when the output section rotates with respect to the base section.

One or more embodiments of the present invention is an electric device characterized in that when the hanging hook is in the storage position, when viewed from the left-right direction, the connecting section is configured to protrude so as not to substantially overlap with the body section and the battery pack.

One or more embodiments of the present invention an electric device which includes a body section configured to convert power to a predetermined conversion output and output the power converted forward, a battery pack detachably mounted to the body section, and a hanging hook connected to the body section to be movable between a storage position and a hooking position, and including a first hook section and a second hook section configured to be hookable onto a long member extending in a left-right direction. In the storage position, the side hook section is positioned on the outer side of the left-right direction of the body section and the hanging hook is disposed at a position at which the hanging hook does not overlap with the battery pack when viewed from a mounting direction side of the battery pack, and in the hooking position, the first hook section and the second hook section protrude to a rear side beyond the body section to be hookable onto the long member.

One or more embodiments of the present invention is an electric device in which the battery pack is mounted to a lower end section of the body section, the hanging hook is positioned above the battery pack, and in the hooking position, the first hook section and the second hook section protrude to the rear side beyond the battery pack.

One or more embodiments of the present invention is an electric device in which the hanging hook is formed in a long rod shape and includes the first hook section constituting one end section in a longitudinal direction of the hanging hook, the second hook section constituting the other end section in the longitudinal direction of the hanging hook, and a connecting section constituting a middle section in the longitudinal direction of the hanging hook, and in the storage position, the first hook section and the second hook section are bent in a U-shape that opens toward the rear side when viewed from the left-right direction, the connecting section connects an upper end section of the first hook section and an upper end section of the second hook section to each other, and a lower end section of the first hook section and a lower end section of the second hook section are bent toward an inner side of the left-right direction and rotatably connected to the body section with the left-right direction as an axial direction.

One or more embodiments of the present invention is an electric device in which the body section includes an output section which outputs the conversion output, a base section to which the battery pack is detachably mounted, and a connection section which is provided on the base section and connects a rear end section of the output section, and in the storage position, the first hook section and the second hook section are positioned on the outer side of the left-right direction of the connection section.

One or more embodiments of the present invention is an electric device in which the connection section covers the rear end section of the output section from an outer side and a rear side of the left-right direction, and includes an opening section which opens upward, the rear end section of the output section is rotatably connected to the connection section with the left-right direction as the axial direction, and in the storage position, the hanging hook is positioned at a position at which the hanging hook does not overlap with the opening section when viewed from above.

One or more embodiments of the present invention is an electric device in which in the storage position, the connecting section is disposed at a distance above the connection section and curved in a circular arc shape that opens forward when viewed from above.

One or more embodiments of the present invention is an electric device in which in the storage position, the connecting section is disposed at a position at which the connecting section overlaps with the connection section when viewed from above.

### Effects

According to one or more embodiments of the present invention, convenience can be improved.

### BRIEF DESCRIPTION OF THE DRAWINGS

FIG. 1 is a side view as viewed from the left side showing a flashlight according to the embodiment.

FIG. 2 is a plan view of the flashlight shown in FIG. 1 as viewed from above.

FIG. 3 is a perspective view of the flashlight shown in FIG. 1, as viewed from the left diagonal front.

FIG. 4 is a cross-sectional view as viewed from the left side showing the interior of the flashlight shown in FIG. 1.

FIG. 5 is a side view showing a state where the light section of the flashlight shown in FIG. 1 is rotated to the upper light projection position.

FIG. 6 is a disassembled perspective view showing the hanging hook of the flashlight shown in FIG. 3 disassembled from the base section.

FIG. 7 is a side view showing a state where the hanging hook of the flashlight shown in FIG. 1 is rotated to the hooking position.

FIG. 8 is a perspective view showing a state where the flashlight shown in FIG. 7 is hung on a single pipe.

FIG. 9 is a perspective view showing a state where the flashlight shown in FIG. 1 is hung on a hook member.

### DESCRIPTION OF EMBODIMENTS

Hereinafter, a flashlight 10 as an electric device according to the present embodiment will be described using the drawings. In the drawings, an arrow UP, an arrow FR, and an arrow LH appropriately shown indicate the upper side, front side, and left side of the flashlight 10, respectively. In the following description, when description is given using up-down, front-rear, and left-right directions, unless specifically noted otherwise, these indicate an up-down direction, a front-rear direction, and a left-right direction of the flashlight 10.

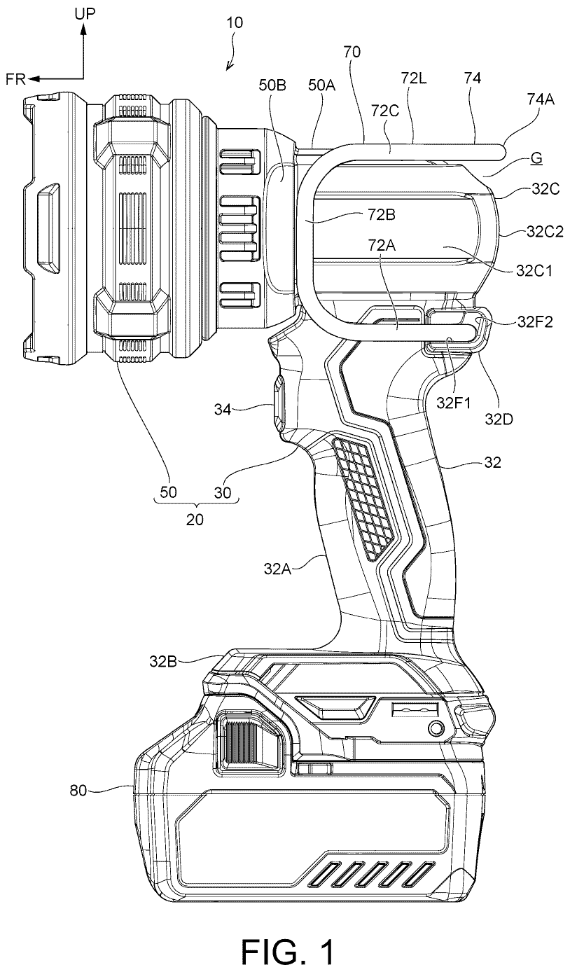

As shown in FIGS. 1 to 7, the flashlight 10 is configured to include a flashlight body 20 as a body section, and a hanging hook 70. The following describes each of the components of the flashlight 10.

(Regarding the flashlight body 20) The flashlight body 20 includes a light support section 30 and a light section 50 as an output section, and the light section 50 is rotatably supported by the light support section 30. The light support section 30 includes a support housing 32 that constitutes the outer frame of the light support section 30. The support housing 32 is formed as a whole in an approximately hollow columnar shape extending in the up-down direction, and is formed in an approximately inverted L-shape when viewed from the left side. Specifically, the support housing 32 is composed of a handle section 32A extending in the up-down direction and a battery mounting section 32B constituting the lower end section of the support housing 32, and the battery mounting section 32B is connected to the lower end section of the handle section 32A. The handle section 32A and the battery mounting section 32B correspond to a base section of the present invention. In addition, the battery mounting section 32B is formed in an approximately hollow flattened shape with the up-down direction as a thickness direction, and protrudes forward from the handle section 32A and also protrudes toward the outer side of the left-right direction.

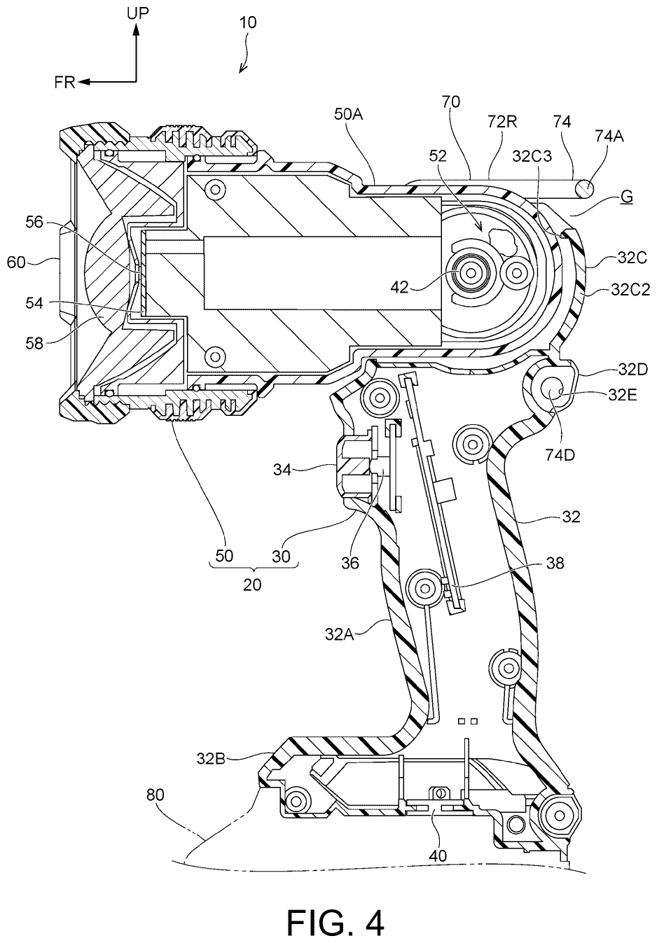

An operation button 34 is provided at the front end section of the upper end side portion of the handle section 32A, and the operation button 34 protrudes forward from the handle section 32A to be pressable toward the rear side. Inside the handle section 32A, a switch 36 (see FIG. 4) is provided at the rear side of the operation button 34, and the switch 36 is electrically connected to a controller 38 (see FIG. 4) housed inside the handle section 32A. When the operation button 34 is pressed, the switch 36 outputs an on signal to the controller 38. A terminal 40 (see FIG. 4) is provided in the battery mounting section 32B, and the terminal 40 is electrically connected to the controller 38. The battery pack 80 is detachably mounted to the battery mounting section 32B. Specifically, the battery pack 80 is mounted to the battery mounting section 32B from the front side. Then, a connector (not shown) of the battery pack 80 is connected to the terminal, and power is supplied from the battery pack 80 to the controller 38.

A support connection section 32C as a connection section that rotatably supports a rear end section of the light section 50 to be described later is provided on the upper side of the handle section 32A of the support housing 32. The support connection section 32C is formed in an approximately U-shape that is open to the front side when viewed in plan view from the upper side, and extends upward from the handle section 32A. Specifically, the support connection section 32C is configured to include a left and right pair of sidewalls 32C1 and a back wall 32C2 connecting the rear end sections of the pair of the sidewalls 32C1 to each other. Accordingly, the support connection section 32C includes an opening section 32C3 that is open to the upper side and front side. The back wall 32C2, when viewed in side view from the left-right direction, is curved in an approximately circular arc shape that is convex toward the rear side, and the upper end section of the back wall 32C2 is disposed at a position one stage lower than the upper end section of the sidewalls 32C1. Also, a connecting shaft 42 (see FIG. 4) having the left-right direction as an axial direction thereof is bridged at approximately the central section of the sidewalls 32C1.

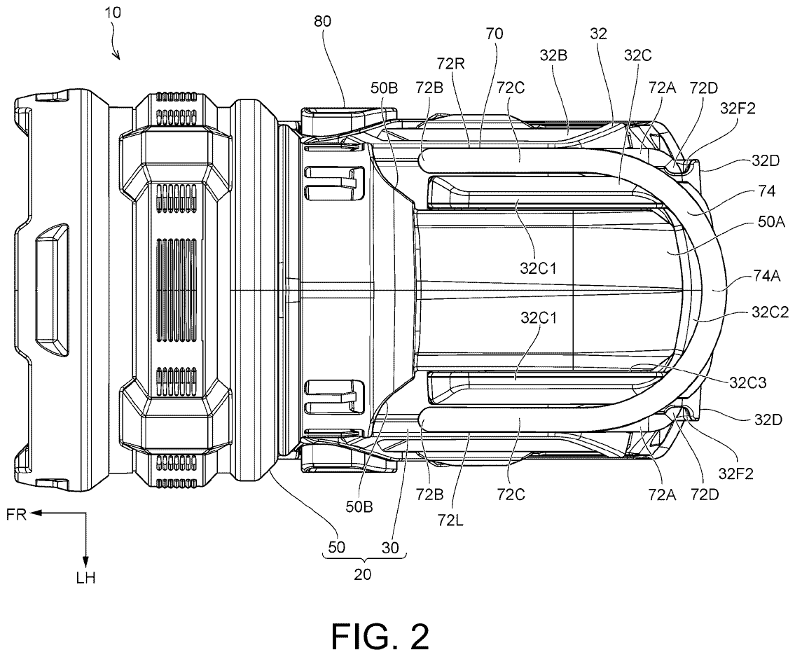

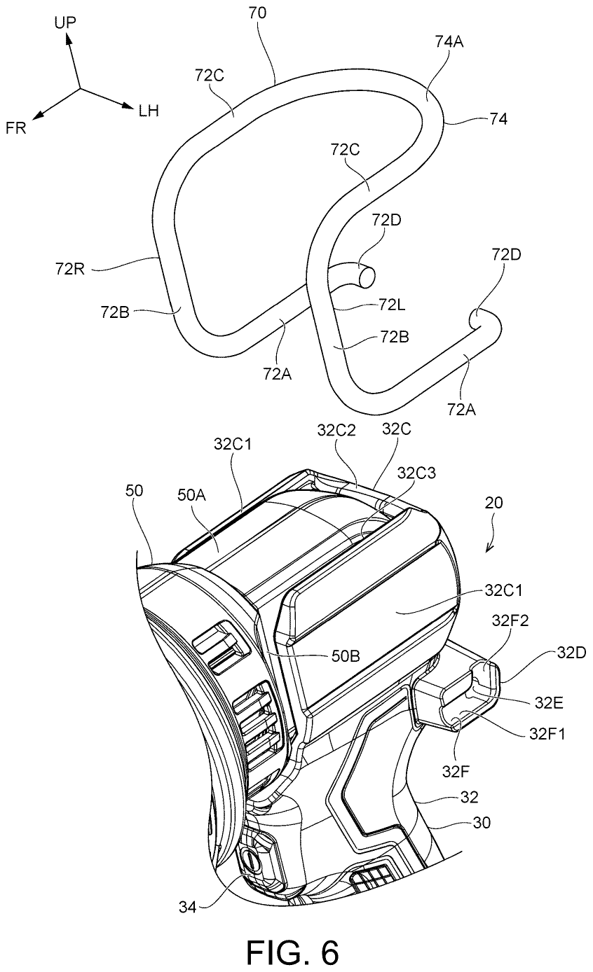

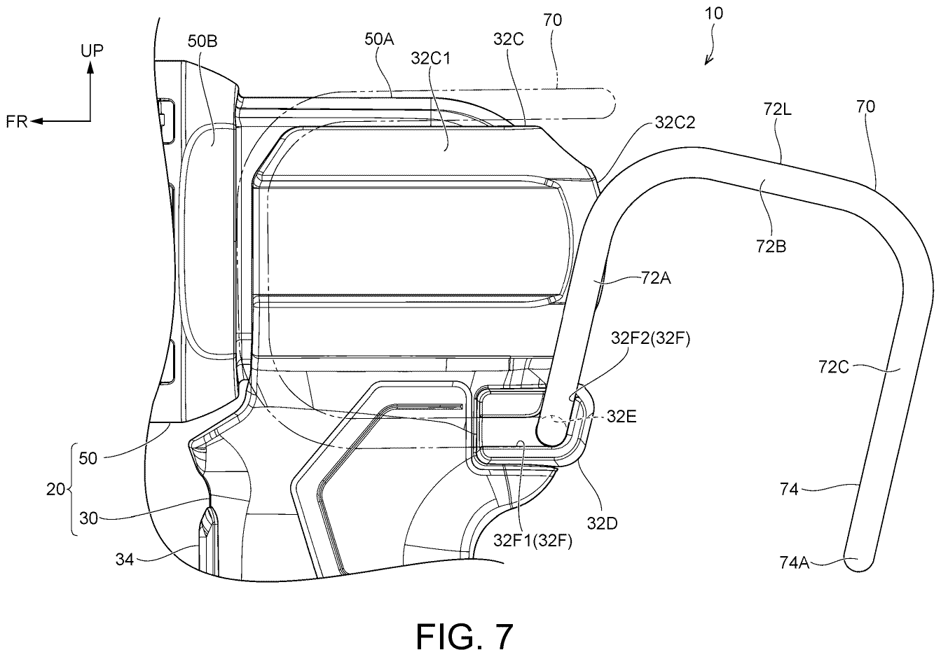

As shown in FIGS. 2, 6, and 7, the support housing 32 is provided with a left and right pair of hook support sections 32D for supporting the hanging hook 70 to be described later, at the rear end section of the upper end side of the handle section 32A (in FIGS. 6 and 7, merely the left side hook support section 32D is shown). The hook support section 32D is formed in an approximately rectangular block shape with the front-rear direction as a longitudinal direction and the up-down direction as the thickness direction, and protrudes from the outer periphery of the handle section 32A toward the outer side of the left-right direction. A support hole 32E is formed to penetrate through the hook support section 32D in the left-right direction. Also, a holding groove 32F that opens toward the outer side of the left-right direction is formed in the hook support section 32D, and the holding groove 32F, when viewed from the left side, is formed in an approximately L-shape with the front-rear direction as the longitudinal direction. Specifically, the holding groove 32F includes a first holding groove section 32F1 extending in the front-rear direction and a second holding groove section 32F2 extending upward from the rear end section of the first holding groove section 32F1, and the support hole 32E is formed at the rear end section of the first holding groove section 32F1.

As shown in FIGS. 1 to 5, the light section 50 is formed as a whole in an approximately hollow stepped cylindrical shape with the front-rear direction as the axial direction in two stages, the outer shape of the front end section of the light section 50 as viewed from the front side is set larger than the outer shape of the middle section in the front-rear direction of the light section 50, and the outer shape of the middle section in the front-rear direction of the light section 50 is set larger than the outer shape of the rear end section of the light section 50.

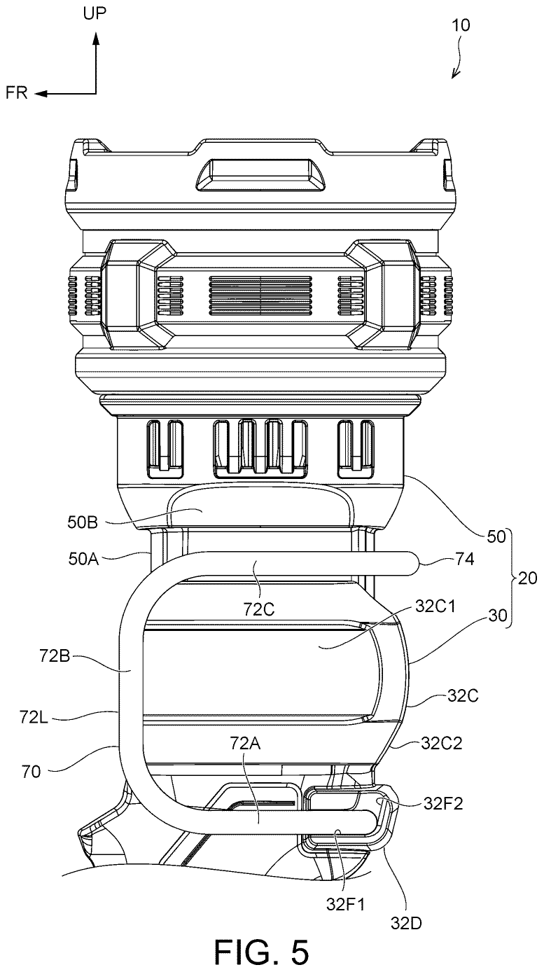

The rear end section of the light section 50 is configured as a connected section 50A. The connected section 50A is disposed inside the support connection section 32C of the light support section 30, and is rotatably supported by the connecting shaft 42. As a result, the light section 50 is rotatably connected to the support connection section 32C with the left-right direction as the axial direction. Specifically, the light section 50 is configured to be rotatable between a front light projection position (position shown in FIGS. 1 to 4) and an upper light projection position (position shown in FIG. 5) which is rotated approximately 90 degrees clockwise from the front light projection position when viewed from the left side. In the front light projection position of the light section 50, the tip side portion (front end side portion) of the connected section 50A protrudes forward from the opening section 32C3 of the support connection section 32C, and in the upper light projection position of the light section 50, the tip side portion (upper end side portion) of the connected section 50A protrudes upward from the opening section 32C3 of the support connection section 32C. Furthermore, a moderation mechanism 52 is provided inside the connected section 50A, and the moderation mechanism 52 is configured as a mechanism section that holds the light section 50 in the front light projection position or the upper light projection position, as well as holds the light section 50 at every predetermined angle (in the embodiment, every 15 degrees) between the front light projection position and the upper light projection position. In the initial state of the flashlight 10, the light section 50 is positioned in the front light projection position, and by a worker's operation to rotate the light section 50 to the upper light projection position, the posture of the light section 50 can be changed according to the work form.

A substrate 54 with front-rear direction as a plate thickness direction is provided at the front end section of the light section 50, and a light source 56 composed of LED etc. is provided on the front surface of the substrate 54. The light source 56 is electrically connected to the controller 38, and is configured to emit light by the control of the controller 38 and to project the emitted light toward the front side. Inside the front end section of the light section 50, a lens 58 is provided at the front side of the light source 56, and a lens cover 60 is attached to the front end section of the light section 50 at the front side of the lens 58. When the operation button 34 is pressed by the worker's operation, and the light source 56 emits light by the control of the controller 38, the light projected from the light source 56 toward the front side passes through the lens 58 and the lens cover 60, thereby illuminating the front side of the light section 50. That is, the light emitted by the light source 56 corresponds to a conversion output of the present invention.

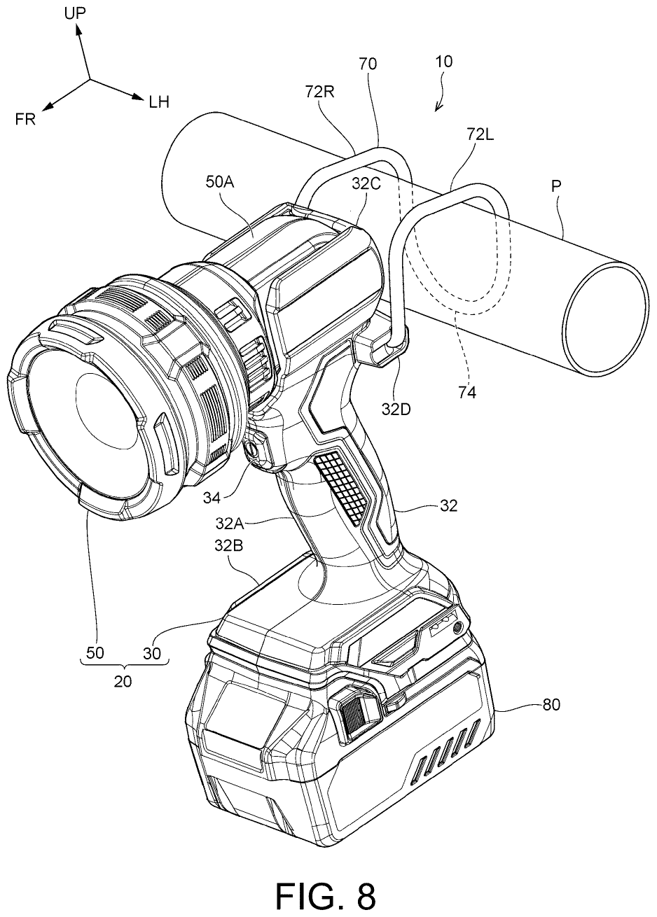

(Regarding the hanging hook 70) As shown in FIG. 8, the hanging hook 70 is configured to be hookable to a single pipe P as a long member extending in the left-right direction, and by hooking the hanging hook 70 to the single pipe P, the flashlight body 20 is designed to be hung from the single pipe P. The hanging hook 70 is rotatably (movably) connected to the light support section 30 of the flashlight body 20, and is configured to be switchable between a storage position (position shown in FIGS. 1 to 5) at which the hanging hook 70 is stored along the outer peripheral section of the light support section 30 and a hooking position (position shown in FIGS. 7 and 8) at which the hanging hook 70 can be hooked to the single pipe P by rotating from the storage position. In the following, the configuration of the hanging hook 70 will be described using the hanging hook 70 disposed in the storage position.

As shown in FIGS. 1 to 6, the hanging hook 70 is constituted by a rod-shaped metal member and is bent into a predetermined shape. Specifically, the hanging hook 70 includes a pair of side hook sections 72L and 72R constituting both side portions in the longitudinal direction of the hanging hook 70, and a center hook section 74 as a connecting section constituting the middle section in the longitudinal direction of the hanging hook 70 and connecting the pair of the side hook sections 72L and 72R. It should be noted that the side hook section 72L corresponds to a first hook section of the present invention, and the side hook section 72R corresponds to a second hook section of the present invention.

The side hook sections 72L and 72R are bent in an approximately U-shape that opens toward the rear side when viewed from the side. Specifically, the side hook sections 72L and 72R are configured to include a first bar section 72A extending in the front-rear direction, a second bar section 72B extending upward from the front end section of the first bar section 72A, and a third bar section 72C extending toward the rear side from the upper end section of the second bar section 72B. The connection section between the first bar section 72A and the second bar section 72B, and the connection section between the second bar section 72B and the third bar section 72C are bent in an approximately circular arc shape. Additionally, the extension length of the third bar section 72C is set to be shorter than the extension length of the first bar section 72A. A hook connecting section 72D that is bent toward the inner side of the left-right direction is formed at the rear end section (both end sections of the hanging hook 70) of the first bar section 72A. The up-down distance between the first bar section 72A and the third bar section 72C and the extension lengths of the first bar section 72A and the third bar section 72C are set so that the single pipe P can be inserted into the side hook sections 72L and 72R.

The center hook section 74 extends in the left-right direction and is curved in an approximately circular arc shape that is open toward the front side when viewed in plan view, and both end sections in the longitudinal direction of the center hook section 74 are connected to the rear end sections of the third bar sections 72C. The rear end section 74A of the center hook section 74 is positioned slightly more toward the rear side than the hook connecting section 72D when viewed from the side.

The side hook sections 72L and 72R are respectively disposed on the outer side of the left-right direction of the support connection section 32C in the light support section 30, and the hook connecting section 72D is rotatably inserted into the support hole 32E of the light support section 30 from the outer side of the left-right direction. As a result, the hanging hook 70 is rotatably connected to the light support section 30 with the left-right direction as the axial direction.

Also, the side hook sections 72L and 72R are positioned to almost overlap with the flashlight body 20 when viewed from the left-right direction. Specifically, when viewed from the left-right direction, the first bar section 72A and the second bar section 72B are positioned to overlap with the light support section 30 (support connection section 32C), and the third bar section 72C is positioned above the support connection section 32C. Furthermore, the center hook section 74 protrudes upward and rearward from the light support section 30 (support connection section 32C) so as to almost not overlap with the battery pack 80. It should be noted that the side hook sections 72L and 72R are disposed on the outer side of the left-right direction of the support connection section 32C, therefore, in plan view, the side hook sections 72L and 72R do not overlap with the opening section 32C3 of the support connection section 32C. Additionally, in plan view, the side hook sections 72L and 72R are positioned to overlap with the battery mounting section 32B. That is, the side hook sections 72L and 72R are disposed so as not to protrude outward in the left-right direction beyond the battery mounting section 32B (see FIG. 2).

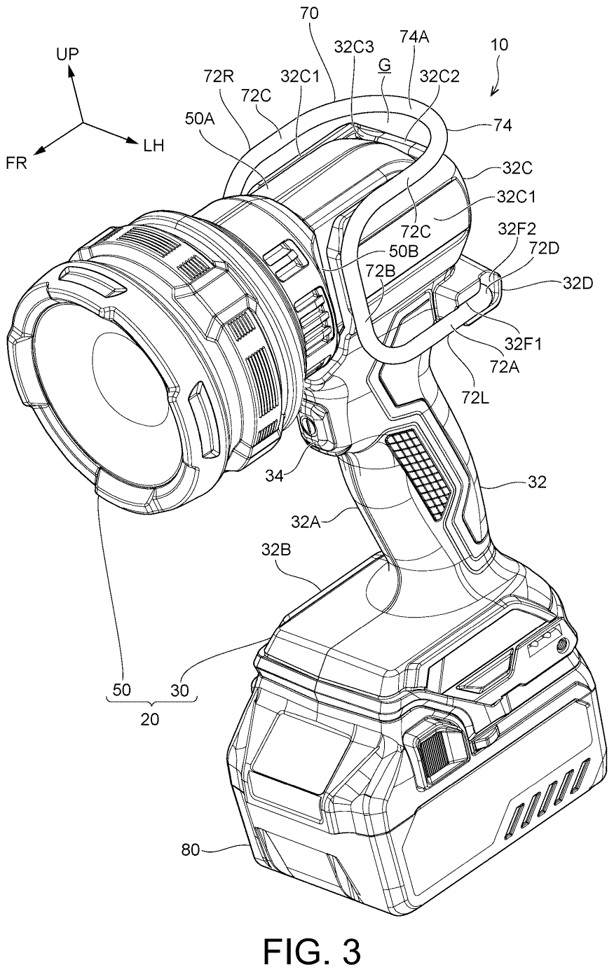

In addition, the center hook section 74 is disposed at a distance above the back wall 32C2 in the support connection section 32C, and a predetermined gap G (see FIGS. 3 and 4) is formed in the up-down direction between the rear end section 74A of the center hook section 74 and the back wall 32C2. Furthermore, in plan view, the center hook section 74 is positioned at the rear side of the opening section 32C3 so that the center hook section 74 and the opening section 32C3 of the support connection section 32C do not overlap. As a result, the connected section 50A of the light section 50 in the upper light projection position protrudes upward from the opening section 32C3 without interfering with the hanging hook 70 (see FIG. 5). Additionally, a notch section 50B is formed on the outer peripheral section of the light section 50 at the front side of the hanging hook 70, and the notch section 50B is disposed at a distance from the front side of the second bar section 72B and, in plan view, inclines toward the outer side of the left-right direction as the notch section 50B moves toward the front side. Thus, during rotation of the light section 50 between the front light projection position and the upper light projection position, the notch section 50B is configured to avoid interference between the light section 50 and the hanging hook 70. Furthermore, since the hanging hook 70 and the battery pack 80 are disposed at positions that are offset in the up-down direction, when viewed from the mounting direction side (front side) of the battery pack 80, the hanging hook 70 is disposed at a position at which the hanging hook 70 does not overlap with the battery pack 80.

Also, in the storage position of the hanging hook 70, the first bar section 72A is inserted into the first holding groove section 32F1, and the first bar section 72A and the first holding groove section 32F1 are engaged, so that the hanging hook 70 is held in the storage position. The first bar sections 72A of the side hook sections 72L and 72R are configured to be elastically deformable in the left-right direction, and when the first bar section 72A elastically deforms toward the outer side of the left-right direction, the insertion state of the first bar section 72A into the first holding groove section 32F1 is released, allowing the hanging hook 70 to rotate from the storage position toward the hooking position side.

As shown in FIGS. 7 and 8, when viewed from the left side, by rotating the hanging hook 70 clockwise by approximately 90 degrees around the hook connecting section 72D, the hanging hook 70 is disposed in the hooking position. In the hooking position, when viewed from the left-right direction, the hanging hook 70 (the side hook sections 72L and 72R and center hook section 74) protrudes toward the rear side so as to almost not overlap with the flashlight body 20 and the battery pack 80. Specifically, in the hooking position, the hanging hook 70 protrudes toward the rear side from the support connection section 32C and the battery pack 80 so that the hanging hook 70 can be hooked to the single pipe P. More specifically, in side view, the side hook sections 72L and 72R are opened downward, and the approximately entire interior of the hanging hook 70 is disposed so as not to overlap with the flashlight body 20. This allows the single pipe P extending in the left-right direction to be inserted into the hanging hook 70, and by hooking the side hook sections 72L and 72R to the single pipe P, the flashlight body 20 is hung from the single pipe P. In the hooking position of the hanging hook 70, the first bar section 72A is inserted into the second holding groove section 32F2, and the first bar section 72A engages with the second holding groove section 32F2, thereby holding the hanging hook 70 in the hooking position.

(Effect) Next, the action and effect of the embodiment will be described.

In the initial state of the flashlight 10 configured as described above, the light section 50 is disposed in the front light projection position, and the hanging hook 70 is disposed in the storage position. When illuminating the front side with the flashlight 10, the worker presses the operation button 34 toward the rear side, causing the light source 56 to emit light by the controller 38, and the emitted light is projected toward the front side. When turning off the flashlight 10, the worker presses the operation button 34 toward the rear side again, causing the light source 56 to be turned off by the controller 38.

Also, when hanging the flashlight 10 on the single pipe P, the hanging hook 70 is rotated clockwise when viewed from the left side. At this time, the side hook sections 72L and 72R of the hanging hook 70 elastically deform toward the outer side of the left-right direction, the engagement state between the first bar section 72A and the first holding groove section 32F1 is released, and rotation of the hanging hook 70 toward the hooking position side is permitted. When the hanging hook 70 is rotated to the hooking position, the first bar sections 72A of the side hook sections 72L and 72R fit into the second holding groove sections 32F2, and the first bar sections 72A engage with the second holding groove sections 32F2. As a result, the hanging hook 70 protrudes further to the rear side than the flashlight body 20 and the battery pack 80 so as to be hookable to the single pipe P. Then, the flashlight 10 is disposed so that the single pipe P is located below the side hook sections 72L and 72R, and the flashlight 10 is moved downward to insert the single pipe P from the opening section of the side hook sections 72L and 72R into the side hook sections 72L and 72R. As a result, the side hook sections 72L and 72R hook onto the single pipe P, and the flashlight body 20 is hung on the single pipe P.

In this way, in the flashlight 10, the hanging hook 70 is connected to the flashlight body 20 so as to be rotatable (movable) between the storage position and the hooking position. In the hooking position, since the side hook sections 72L and 72R protrude so as not to substantially overlap with the flashlight body 20 and the battery pack 80, the hanging hook 70 can be stably hooked on the single pipe P. On the other hand, in the storage position, since the side hook sections 72L and 72R are stored so as to substantially overlap with the flashlight body 20, the hanging hook 70 can be compactly stored. Also, the center hook section 74 can stabilize the relative position of the side hook sections 72L and 72R in the hooking position. Furthermore, since the center hook section 74 does not overlap with at least the battery pack 80 in the storage position, attachment and detachment of the battery pack 80 may be enabled. As a result, the convenience of the flashlight 10 can be improved.

More specifically, in the storage position of the hanging hook 70, the side hook section 72 is positioned on the outer side of the left-right direction of the flashlight body 20. Accordingly, in the storage position of the hanging hook 70, the side hook section 72 is disposed to overlap with the flashlight body 20 in side view, so that when the hanging hook 70 is not in use, the hanging hook 70 can be stored along the outer peripheral section of the flashlight body 20. Moreover, in the storage position of the hanging hook 70, when viewed from the front side (mounting direction side of the battery pack 80), the hanging hook 70 is disposed at a position at which the hanging hook 70 does not overlap with the battery pack 80. Therefore, interference between the battery pack 80 and the hanging hook 70 can be avoided during attachment and detachment of the battery pack 80. That is, with the hanging hook 70 in the storage position, the battery pack 80 can be attached and detached. Also, in the hooking position of the hanging hook 70, the side hook section 72 is disposed at the rear side of the flashlight body 20 so as to be hookable to the single pipe P. That is, in the hooking position of the hanging hook 70, the flashlight body 20 is not disposed below the hanging hook 70, so the side hook section 72 can be easily hooked onto the single pipe P positioned below the side hook section 72. Based on the above, according to the flashlight 10 of the embodiment, the convenience of the flashlight 10 can be improved.

In addition, the flashlight body 20 is configured to include the light section 50 having the light source 56, the light support section 30 having the battery mounting section 32B to which the battery pack 80 is detachably mounted, and the support connection section 32C provided on the light support section 30. The connected section 50A of the light section 50 is connected to the support connection section 32C, and in the storage position of the hanging hook 70, the side hook sections 72L and 72R are positioned on the outer side of the left-right direction of the support connection section 32C. That is, the support connection section 32C, the light section 50 positioned near the support connection section 32C, the handle section 32A, and the battery mounting section 32B are positioned between the side hook section 72L and the side hook section 72R in the left-right direction. This allows the hanging hook 70 to be compactly stored around (on the outer side of the left-right direction of) the support connection section 32C.

In addition, the support connection section 32C covers the connected section 50A of the light section 50 from the outer side and rear side of the left-right direction, and has the opening section 32C3 that is open toward the upper side, and the connected section 50A is rotatably supported by the connecting shaft 42 that is bridged across the sidewall 32C1 of the support connection section 32C. Furthermore, in the storage position of the hanging hook 70, the hanging hook 70 is positioned at a position at which the hanging hook 70 does not overlap with the opening section 32C3 in plan view. That is, in the storage position of the hanging hook 70, the center hook section 74 is disposed at a position at which the center hook section 74 does not contact the light section 50 that rotates with respect to the light support section 30. In this way, interference between the light section 50 and the hanging hook 70 may be avoided when the light section 50 is rotated to the upper light projection position, allowing the light section 50 to protrude upward from the opening section 32C3.

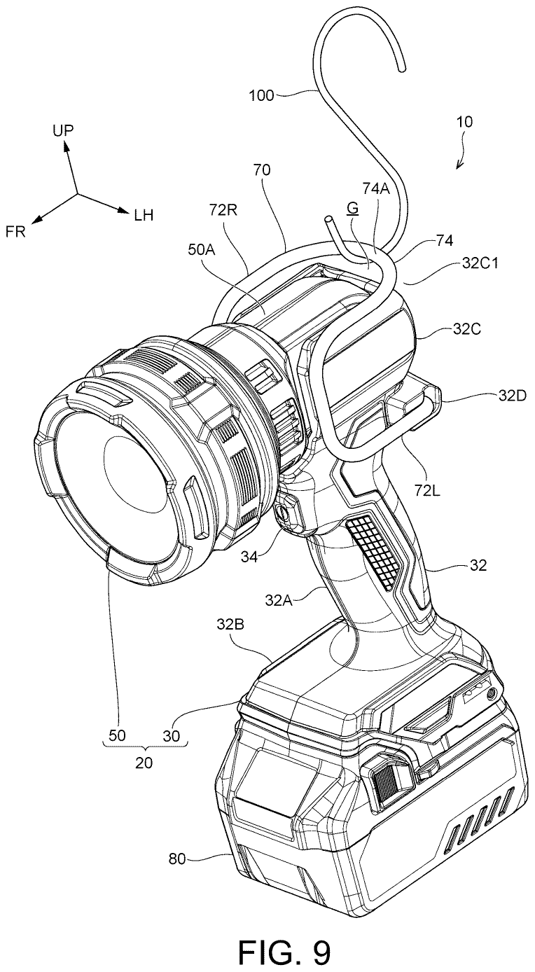

Also, in the storage position of the hanging hook 70, the center hook section 74 is disposed at a distance above the support connection section 32C, and is curved in an approximately circular arc shape that opens toward the front side when viewed from above. That is, in the storage position of the hanging hook 70, when viewed from the left-right direction, the center hook section 74 protrudes upward so as not to substantially overlap with the flashlight body 20 and the battery pack 80. Specifically, the rear end section 74A of the center hook section 74 is disposed with the predetermined gap G above the back wall 32C2 of the support connection section 32C. As a result, as shown in FIG. 9, for example, by inserting the lower end section of an S-shaped rod-like hook member 100 into the gap G to hook the rear end section 74A of the center hook section 74 to the hook member 100, and by hooking the upper part of the hook member 100 to the single pipe P, the flashlight body 20 with the hanging hook 70 in the storage position can be hung from the single pipe P. Therefore, the convenience of the flashlight 10 can be further improved.

In addition, in the storage position of the hanging hook 70, the center hook section 74 is disposed at a position at which the center hook section 74 overlaps with the support connection section 32C when viewed from the upper side. In this way, the center hook section 74 may be prevented from excessively protruding to the rear side beyond the support connection section 32C in the storage position of the hanging hook 70. Therefore, the enlargement of the hanging hook 70 may be prevented, and consequently, the enlargement of the flashlight 10 may be prevented.

Moreover, the battery pack 80 is mounted to the lower end section of the flashlight body 20, and the hanging hook 70 is positioned above the battery pack 80. Furthermore, in the hooking position of the hanging hook 70, the side hook sections 72L and 72R protrude to the rear side beyond the battery pack 80. This allows for suppression of interference between the single pipe P positioned below the side hook sections 72L and 72R and the battery pack 80 when hooking the side hook sections 72L and 72R to the single pipe P. Therefore, the convenience of the flashlight 10 can be further improved. Also, by mounting the battery pack 80 to the lower end section of the flashlight body 20, the battery pack 80 can be configured as the lower end section of the flashlight 10. This allows, for example, the battery pack 80 to be disposed on the ground etc., enabling the flashlight 10 to be disposed in an upright state on the ground.

Furthermore, in plan view, the side hook sections 72L and 72R overlap with the battery mounting section 32B. This allows for the disposition of a pair of hanging hooks 70 on the outer side of the left-right direction of the support connection section 32C while suppressing the enlargement of the size of the hanging hook 70 in the left-right direction.

### REFERENCE SIGNS LIST

10 flashlight (electric device); 20 flashlight body (body section); 32A handle section (base section); 32B battery mounting section (base section); 32C support connection section (connection section); 50 light section (output section); 70 hanging hook; 72L side hook section (first hook section); 72R side hook section (second hook section); 74 center hook section (connecting section); 80 battery pack; P single pipe (long member)

1. An electric device, comprising:
a body section, configured to convert power to a predetermined conversion output and output the power converted forward;
a battery pack, detachably mounted to the body section; and
a hanging hook, configured to be connected to the body section and hung on an external long member extending in a left-right direction, and
the hanging hook comprising a first hook section which is configured to have one end connected to the body section and hook onto the long member, a second hook section which is configured to be provided at a position shifted in the left-right direction with respect to the first hook section, have one end connected to the body section, and hook onto the long member, and a connecting section which connects the other end of the first hook section and the other end of the second hook section so as not to move relative to each other, and
the hanging hook being configured to be movable between a hooking position at which when viewed from the left-right direction, the first hook section, the second hook section, and the connecting section protrude so as not to substantially overlap with the body section and the battery pack and a storage position at which the first hook section and the second hook section are stored so as to substantially overlap with the body section, and the connecting section protrudes so as not to substantially overlap with at least the battery pack.

2. The electric device according to claim 1, wherein
the body section comprises an output section configured to output the conversion output, a base section configured to allow the battery pack to be detachable, and a connection section which connects the output section and the base section to be rotatable relative to each other, and
the connection section and the output section and the base section positioned near the connection section are all configured to be positioned between the first hook section and the second hook section when placed in the left-right direction.

3. The electric device according to claim 2, wherein when the hanging hook is in the storage position, the connecting section is configured to be in a position at which the connecting section does not contact the output section when the output section rotates with respect to the base section.

4. The electric device according to claim 1, wherein when the hanging hook is in the storage position, when viewed from the left-right direction, the connecting section is configured to protrude so as not to substantially overlap with the body section and the battery pack.

5. An electric device, comprising:
a body section, configured to convert power to a predetermined conversion output and output the power converted forward;
a battery pack, detachably mounted to the body section; and
a hanging hook, connected to the body section to be movable between a storage position and a hooking position, and comprising a first hook section and a second hook section configured to be hookable onto a long member extending in a left-right direction, and
in the storage position, the first hook section and the second hook section being positioned on an outer side of the left-right direction of the body section and the hanging hook is disposed at a position at which the hanging hook does not overlap with the battery pack when viewed from a mounting direction side of the battery pack, and
in the hooking position, the first hook section and the second hook section protruding to a rear side beyond the body section to be hookable onto the long member.

6. The electric device according to claim 5, wherein
the battery pack is mounted to a lower end section of the body section, and the hanging hook is positioned above the battery pack, and
in the hooking position, the first hook section and the second hook section protrude to the rear side beyond the battery pack.

7. The electric device according to claim 5, wherein
the hanging hook is formed in a long rod shape and comprises the first hook section constituting one end section in a longitudinal direction of the hanging hook, the second hook section constituting the other end section in the longitudinal direction of the hanging hook, and a connecting section constituting a middle section in the longitudinal direction of the hanging hook, and
in the storage position, the first hook section and the second hook section are bent in a U-shape that opens toward the rear side when viewed from the left-right direction, the connecting section connects an upper end section of the first hook section and an upper end section of the second hook section to each other, and a lower end section of the first hook section and a lower end section of the second hook section are bent toward an inner side of the left-right direction and rotatably connected to the body section with the left-right direction as an axial direction.

8. The electric device according to claim 7, wherein
the body section is configured to comprise
an output section which outputs the conversion output,
a base section to which the battery pack is detachably mounted, and
a connection section which is provided on the base section and connects a rear end section of the output section, and
in the storage position, the first hook section and the second hook section are positioned on an outer side of the left-right direction of the connection section.

9. The electric device according to claim 8, wherein
the connection section covers the rear end section of the output section from an outer side and a rear side of the left-right direction and comprises an opening section which opens upward,
the rear end section of the output section is rotatably connected to the connection section with the left-right direction as the axial direction, and
in the storage position, the hanging hook is positioned at a position at which the hanging hook does not overlap with the opening section when viewed from above.

10. The electric device according to claim 9, wherein in the storage position, the connecting section is disposed at a distance above the connection section and curved in a circular arc shape that opens forward when viewed from above.

11. The electric device according to claim 9, wherein in the storage position, the connecting section is disposed at a position at which the connecting section overlaps with the connection section when viewed from above.
